(19) United States
(12) Patent Application Publication
(10) Pub. No.: US 2002/0031538 A1
(43) Pub. Date: Mar. 14, 2002

(54) Light activateable natural pesticide formulations

(76) Inventor: Louis Michael Scarmoutzos, Melrose, MA (US)

Correspondence Address: Louis M. Scarmoutzos, Unit 204, 340 Main Street, Melrose, MA, 02176, US

(21) Appl. No.: 09/951,013

(22) Filed: Sep. 11, 2001

Related U.S. Application Data
(60) Provisional application No. 60/231,749, filed on Sep. 11, 2000.

(51) Int. Cl. A01N 25/00; A01N 65/00

(52) U.S. Cl. 424/405; 424/45; 424/46; 424/725; 424/730

(57) ABSTRACT

The present invention is for natural pesticide compositions including methods for their preparation and use. The pesticide compositions of the present invention contain botanical extracts which exert enhanced pesticidal activity when combined with light.

### CROSS-REFERENCE TO RELATED APPLICATIONS

This application claims the benefit under 35 U.S.C. § 119(e) of United States Provisional Patent Application No. 60/231,749 filed Sep. 11, 2000.

### STATEMENT REGARDING FEDERALLY SPONSORED RESEARCH OR DEVELOPMENT

Not Applicable.

### REFERENCE TO AN ELECTRONIC DOCUMENT APPENDIX

Not Applicable.

### BACKGROUND OF THE INVENTION

1. Field of the Invention

This invention is for compositions and formulations that have pesticidal activities and methods for their preparation and use. The compositions and formulations of the present invention are natural compositions or biodegradable compositions that are suitable for use as pesticides. The compositions, and formulations of the present invention incorporate one or more naturally occurring photoactivateable components, which exert their pesticidal activity- including antibacterial and antiviral activities—primarily in the presence of light. The present invention further relates to a method for the control of pests, which comprises exposing the pest to compositions and formulations of the present invention in combination with light. The compositions and formulations of the present invention may also incorporate other non-photoactivateable pesticides, including bactericides, viricides and pesticides, and repellents. The present invention further relates to methods for the preparation of compositions of the present invention in the absence of harmful ultraviolet, visible and near-infrared light. Preparation of the compositions of the present invention in the absence of light results in enhanced pesticidal properties. The compositions and formulations of the present invention are environmentally friendly and toxicologically safe.

2. Description of Prior Art

Biodegradable and natural pesticides are viable alternatives to the use of synthetic chemical pesticides and formulations for the control of pests, weeds, unwanted plants, bacteria, viruses and germs. Biodegradable and natural pesticides offer many advantages over their synthetic counterparts. They are characteristically short-lived in the environment and usually break down readily and relatively rapidly in the soil or in the atmosphere. Biodegradable and natural pesticides are usually not stored or accumulated in plant or animal tissue. In general, natural pesticides are less toxic and more environmentally compatible than synthetic pesticides.

There is a growing demand for novel pesticides, particularly for consumer home and garden use. Consumer and homeowner sentiment is increasingly favoring eco-friendly and green alternatives over conventional, synthetic pesticides. Many of the synthetic or conventional pesticides have had or have the perception of having adverse environmental and health effects. Increasing numbers of conventional, synthetic pesticides are being removed from the market or are not being re-registered by the Environmental Protection Agency (EPA) due to environmental and health concerns. Dursban (also known as chlorpyrifos, a member of the organophosphate class of insecticides), which is the most widely used household pesticide in the United States, has recently been eliminated for use in all household purposes by the EPA. Sales of Dursban products to household consumers will end Dec. 31, 2001.

There is a growing concern that increasingly higher concentrations of long-lived synthetic pesticides are finding their way into fresh water supply systems due to increasing consumer usage and storm water run-off. The biodegradable and natural pesticide compositions and formulations of the present invention are viable eco-friendly alternatives to these relatively long-lived synthetic pesticides.

Certain agricultural practices or agricultural modes that are becoming increasingly more popular, such as organic farming, organic agriculture and sustainable agricultural practices preclude or prohibit the use of antibiotics, synthetic pesticides, agricultural chemicals, and genetically modified plants and organisms. Many organic products from organic farming do not have suitable pesticide materials and must rely on the natural elements to assist them in their growth and harvest. The pesticide compositions and formulations of the present invention are suitable for use in organic farming and organic agriculture and have the potential of increasing organic crop yields.

A key concern with existing pesticides, both natural and synthetic, is that there is an increasing incidence of resistance to their use. There are a decreasing number of safe and effective pesticides available for agricultural, industrial, household and workplace use.

There are a number of commercially available natural pesticides. Commercially available natural pesticides include, in part, the pyrethrins, rotenones, and nicotine. Also available as natural pesticides and natural repellents are extracts from the neem tree, tobacco plants, citrus plants and citrus fruits to name a few. There is a growing concern that existing commercially available natural pesticides may be more harmful to human health than first thought. Recent studies have suggested that the pyrethrins may play an active role in the development of neurodegenerative diseases.

There are a number of naturally occurring inorganic pesticides including sulfur-based materials and metal salts such as the copper salts. However, these materials usually have an unfavorable environmental impact on the local environment as well as downstream from their use and application.

The compositions and formulations of the present invention, including methods for their preparation and use, are effective, eco-friendly alternatives to existing commercially available synthetic or natural materials. A particularly useful and distinct feature of the present invention is the combination of light and compositions of the present invention for the treatment and control of agricultural, household and workplace pests such as bacteria, viruses, germs, fungi, insects, rodents, unwanted vegetation and weeds.

### BRIEF SUMMARY OF THE INVENTION

The present invention relates to pesticide compositions and methods for the safe and effective control of pests. The present invention further relates to a method of preparing environmentally safe and effective pesticide compositions for the control of agricultural, industrial, household and workplace pests. The present invention takes advantage of the fact that there are naturally existing materials, or natural products, that become chemically reactive and harmful to pests when such materials, or pests which have ingested or come into contact with such materials, are exposed to light.

A pesticide is defined as any substance that prevents, repels, destroys or mitigates a pest. The term pest refers to insects, mice and other animals, unwanted plants, weeds, fungi, and microorganisms such as bacteria and viruses. The term pesticide includes insecticides, fungicides, herbicides, defoliants, antimicrobials, miticides, nematicides, ovicides, rodenticides, repellents, algicides, biocides, disinfectants and sanitizers.

A notable feature in preparing the compositions and formulations of the present invention is to prepare and manipulate the raw materials, intermediates and finished products in the absence of light. In particularly, the compositions and formulations of the present invention should be prepared and formulated under conditions that filter or remove those components or wavelengths of light that degrade their activity, namely the ultraviolet, visible and near-infrared wavelengths of the electromagnetic spectrum. Failure to employ such photoprotective conditions results in pesticidal activity that is greatly diminished or lost.

Activation of the pesticidal activity is accomplished largely by exposure of the pest, including bacteria, virus, germ or organism, to light from either synthetic or natural sources, after first treating or exposing said pest, including bacteria, virus germ or organism, to compositions and formulations of the present invention. In some compositions of the present invention, mixed modes of pesticidal action are observed- a pesticidal killing or controlling mechanism which occurs in the dark and another which occurs in the presence of light. The use of the compositions and formulations of the present invention in combination with light results in enhanced pesticidal activity.

### DETAILED DESCRIPTION OF THE INVENTION

The present invention is for natural and biodegradable compositions and formulations that are pesticides, including antiviral agents, antibacterial agents and repellents; methods for preparing said pesticidal compositions and formulations in the absence of harmful light, including antibacterial, antiviral, and repellent compositions and formulations; and, methods for using said pesticidal compositions and formulations in controlling agricultural, industrial, household and workplace pests, including antibacterial, antiviral, and repellent compositions and formulations. Control of agricultural, industrial, household and workplace pests, including viruses, germs and bacteria, is accomplished by exposing said pests, including germs, bacteria and viruses, to the formulations and compositions of the present invention. Enhanced pesticidal activity, including bactericidal and viricidal activity, is observed when pests, including germs, bacteria and viruses, are exposed to the formulations and compositions of the present invention in combination with light.

The compositions and formulations of the present invention contain botanical extracts and components from one of more of the following botanical sources: Umbelliferae (for example celery, parsley and parsnips), Rutaceae (for example limes, cloves and bergamot), Leguminosae (for example Psoralen coryfolia), Moraceae (for example figs), Hypericaceae (for example St. John's wort), Compositae, Berberidaceae, Rubiaceae, Simaroubaceae, Guttiferae, Polygonaceae, Asteraceae, Apiaceae, Araliaceae, Campanulaceae, and Solanaceae.

The extracts and components of the compositions of the present invention are prepared according to the following steps, all in the absence of harmful ultraviolet, visible and near-infrared light:

a.) the botanical is washed, cut or homogenized, and then dried to remove significantly all of the water;

b.) the dried botanical material is disintegrated into small manageable pieces or powderized;

c.) the material or powder so obtained in (b) is extracted using supercritical fluids;

d.) the material or powder so obtained in (b) is extracted using non-supercritical fluids;

e.) the material or powder so obtained in (b) is extracted with an organic solvent;

f.) the extraction solvent in (e) may be ethanol or grain alcohol or a solvent or solvent mixture of similar polarity;

g.) the extraction step (e) may be accomplished by use of heat and in the presence of an inert atmosphere;

h.) the extract from steps (c), (d), and (e) is isolated or filtered from the botanical to remove any solids and suspended matter;

i.) the isolated or filtered extract so obtained in step (h) is concentrated at atmospheric pressure or preferably under vacuum;

j.) the concentrate from step (i) may be further concentrated to dryness;

k.) the concentrate from step (i) or the residue from step (j) may be further refined or fractionated for optimal pesticidal activity by chromatographic separation or fractionation or selective solvent extractions and triturations;

l.) the pesticidal activity of the fractions from step (k) may be optimized, monitored and assayed by determining said fraction's biocidal activity when exposed to light;

m.) the biocidal activity of the fractions from step (l) may be determined by exposing bacteria (E. Coli) to said fraction under mild UV (ultraviolet light) irradiation.

The botanical components and extracts comprising compositions of the present invention may be formulated with added adjuvants and additives. Adjuvants include acidifiers, antifoaming agents, antitranspirants, buffering agents, compatibility agents, crop oil, crop oil concentrates, defoamers, drift retardants, extenders, organosilicon surfactants, penetrants, spreaders, spreader-stickers, stickers, surfactants (surface active agents, wetting agents), suspension agents, thickeners, and vegetable oil concentrates.

Additives include animal nutrients, attractants, antioxidants, bait, coloring agents, emulsifying agents, flavoring agents, pH modifying agents, pheromones, photosensitizers, photostabilizers, photoprotectants, plant nutrients, preservatives, release agents, soil nutrients, stabilizers, and storage agents.

The compositions of the present invention may be formulated and applied as powders, aerosols, fogs, sprays, emulsions, liquids or solutions. The liquid or solutions may be aqueous based or solvent based. The compositions of the present invention may be used as 100% concentrates or as mixtures or solutions and incorporated into agricultural chemicals.

The compositions of the present invention alone or in combination with light exposure are also suitable for use as antifouling agents, algicides, ovicides, and microbial pesticides and as disinfectants and sanitizers.

The compositions and formulations of the present invention are used according to the following steps:

a.) exposure or treatment of pests- including insects, rodents, fungi, bacteria, viruses, and germs-or their habitat or their foodstuff or their surroundings with compositions or formulations of the present invention or, alternatively;

b.) the compositions or formulations of the present invention are ingested by livestock, poultry, farm animals, household pets and household animals or, alternatively;

c.) the compositions or formulations of the present invention are applied to agricultural crops, household plants and garden plants or, alternatively;

d.) the compositions or formulations of the present invention are applied to livestock, poultry, farm animals, household pets and household animals or, alternatively;

e.) the compositions or formulations of the present invention are applied to animal, poultry and pet droppings or excrement;

f.) enhanced activity results when subjecting said treated pests- including insects, rodents, fungi, bacteria, viruses, and germs- or their habitat or their foodstuff or their surroundings in step (a) to light;

g.) enhanced activity results when subjecting said treated livestock, poultry, farm animal, household pet and household animal in step (b) and (d) to light;

h.) enhanced activity results when subjecting said treated agricultural crop, household plant and garden plant in step (c) to light;

i.) enhanced activity results when subjecting said treated animal, poultry and pet droppings or excrement in step (e) to light;

j.) the light in step (f), (g), (h), and (i) may be from the visible, ultraviolet or near-infrared region of the electromagnetic spectrum;

k.) the light in step (f), (g), (h), and (i) may be natural sunlight or light derived from synthetic sources.

The methods and compositions of the present invention may be coupled or combined with integrated pest management or with other pesticides, repellants and attractants.

The following non-limiting examples illustrate methods of preparing compositions of the present invention:

### EXAMPLE 1

Celery (4,810 grams) was washed with a mild detergent then rinsed thoroughly with water and air-dried. The celery, including leaves, stem, stalk, and base, was cut into small portions and air-dried in the absence of light. The resulting dried celery (180.6 grams) was powderized and transferred into a 2 liter Erlenmeyer Flask to which was added 800 mL (milliliters) of ethanol (reagent alcohol). The flask was stoppered and let sit in the dark for 7 days (with occasional agitation) and then filtered. This batch extraction process was repeated for a total of 3 times. The combined alcohol extracts (approximately 2.4 liters) were distilled to dryness in the absence of light (yield=8.3 grams). Biocidal activity was demonstrated by treatment of E. coli bacteria with the extract and then exposing the extract treated bacteria to mild ultraviolet irradiation.

### EXAMPLE 2

Celery (6,000 grams) was washed with a mild detergent then rinsed thoroughly with water and air-dried. The celery, including leaves, stem, stalk, and base, was cut into small portions and placed into a blender and homogenized to the consistency of a puree, all the while minimizing its exposure to light. For the sake of handling, a small amount of distilled or deionized water was added. The material was then poured into containers and air-dried in the absence of light. The resulting dried celery material (292.7 grams) was transferred into a 4-liter flask to which was added 1,800 mL of reagent grade alcohol. The contents of the flask were shielded from exposure to light. The flask was then fitted with a mechanical stirrer, reflux condenser, heating mantle and the complete apparatus was shielded from exposure to light. The contents of the flask were heated to 60° C. while stirring for a period of 6 hours. The resulting green liquid was then decanted from the flask and filtered in the dark. An additional 1,800 mL of fresh alcohol was added to the flask and the extraction process was repeated for a total of three times. The combined alcohol extracts were distilled to dryness under reduced pressure and in the absence of light and yielded 55.3 grams of a brown solid.

The following non-limiting examples illustrate compositions and formulations of the present invention. All manipulations, as well as storage of solutions, are conducted in the absence of harmful light.

### EXAMPLE 3

50.0 grams of celery extract from Example 2 is mixed with 50.0 mL (milliliters) of deionized water and stirred vigorously in the dark for several hours or overnight to form a homogenous mixture.

### EXAMPLE 4

25.0 grams of celery extract obtained as described in Example 2 is mixed with 75.0 mL of deionized water and stirred vigorously in the dark for several hours or overnight to form a homogenous mixture.

### EXAMPLE 5

25.0 grams of celery extract obtained as described in Example 2 is mixed with 75.0 ml of distilled water and 5.0 mL of Hasten™ (a commercially available adjuvant from the Wilbur-Ellis Company) and stirred vigorously in the dark for several hours or overnight to form a homogenous mixture.

### EXAMPLE 6

25.0 grams of celery extract obtained as described in Example 2 is mixed with 175.0 ml of distilled water and 5.0 mL of Hasten™ (commercially available adjuvant from the Wilbur-Ellis Company) and stirred vigorously in the dark for several hours to form a homogenous mixture.

### EXAMPLE 7

A concentrate of St. John's wort (SJW) extract is prepared by combining 100 mL of deionized water and 100 grams of St. John's wort (SJW) extract prepared as described by the procedure presented in Example 1 or Example 2 (so obtained by using the flower, leaves and stem of the plant, and a solvent system composed of ethanol: water, 20:1, v/v). Alternatively, a concentrate is prepared by using a commercially available SJW extract standardized to 0.01%-10.0% hypericins (total dianthrones). The deionized water and SJW extract powder (obtained commercially or prepared as described above) are mixed and stirred vigorously in the dark for several hours or overnight to form a homogenous mixture. A formulation was prepared by combining 76.9 mL of the concentrate, 804.3 mL of deionized water, and 47.3 mL of Triton X-100 (a commercially available surfactant from the Union Carbide Company). The pH of the resulting solution is adjusted to pH 8.5 using concentrated NaOH (aq.) and the final formulation is filtered through a Buchner Funnel. All manipulations, as well as storage, of the concentrate and derived formulations are conducted in the absence of harmful light.

### EXAMPLE 8

A concentrate of St. John's wort (SJW) extract is prepared by combining 100 mL of deionized water and 100 grams of St. John's wort (SJW) extract prepared as described by the procedure presented in Example 1 or Example 2 (so obtained by using the flower, leaves and stem of the plant, and a solvent system composed of ethanol: water, 20:1, v/v). Alternatively, a concentrate is prepared by using a commercially available SJW extract standardized to 0.01%-10.0% hypericins (total dianthrones). The deionized water and SJW extract powder (obtained commercially or prepared as described above) are mixed and stirred vigorously in the dark for several hours or overnight to form a homogenous mixture. A formulation was prepared by combining 47.3 mL of the concentrate, 875.3 mL of deionized water, and 23.7 mL of Triton X-100 (a commercially available surfactant from the Union Carbide Company). The pH of the resulting solution is adjusted to pH 8.5 using concentrated NaOH(aq.) and the final formulation is filtered through a Büchner Funnel. All manipulations, as well as storage, of the concentrate and derived formulations are conducted in the absence of harmful light.

### EXAMPLE 9

A concentrate of St. John's wort (SJW) extract is prepared by combining 100 mL of deionized water and 100 grams of St. John's wort (SJW) extract prepared as described by the procedure presented in Example 1 or Example 2 (so obtained by using the flower, leaves and stem of the plant, and a solvent system composed of ethanol: water, 20:1, v/v). Alternatively, a concentrate is prepared by using a commercially available SJW extract standardized to 0.01%-10.0% hypericins (total dianthrones). The deionized water and SJW extract powder (obtained commercially or prepared as described above) are mixed and stirred vigorously in the dark for several hours or overnight to form a homogenous mixture. From this concentrate, a 10:1 formulation (distilled water:concentrate, v/v) and a 5:1 formulation (distilled water:concentrate, v/v) were prepared.

### EXAMPLE 10

A concentrate of St. John's wort (SJW) extract is prepared by combining 100 mL of deionized water and 100 grams of St. John's wort (SJW) extract prepared as described by the procedure presented in Example 1 or Example 2 (so obtained by using the flower, leaves and stem of the plant, and a solvent system composed of ethanol: water, 20:1, v/v). Alternatively, a concentrate is prepared by using a commercially available SJW extract standardized to 0.01%-10.0% hypericins (total dianthrones). The deionized water and SJW extract powder (obtained commercially or prepared as described above) are mixed and stirred vigorously in the dark for several hours or overnight to form a homogenous mixture. A formulation was prepared by combining 100 mL of SJW concentrate, 100 mL of distilled water and 100 mL of Hasten™ (a commercially available adjuvant from the Wilbur-Ellis Company).

The following non-limiting examples illustrate methods of using the compositions and formulations of the present invention for controlling or killing pests:

### EXAMPLE 11

A 1% mixture in water (w/v) of an alcohol extract prepared as described in Example 1 is used to swab a gridded agar plate seeded with E. Coli. The agar plate is irradiated with mild ultraviolet light (254 nm) for a period of 1-2 minutes and then incubated for 24 hours to promote bacterial growth. Grid areas swabbed with the celery extract from Example 1 showed no bacterial growth, as evidenced by staining. As a control, grids treated with a hexane extract of celery (prepared according to the procedure described in Example 1) showed significant bacterial growth (E. Coli), as evidenced by staining.

### EXAMPLE 12

A sample vial containing 20 fruit flies (drosophila melanogaster) is lightly sprayed with the composition and formulation prepared in Example 6. Within 20 minutes all of the fruit flies were dead (Kill Ratio=100%). The control experiments consisting of: (a) lightly spraying a vessel containing 20 fruit flies with distilled water; and, (b) lightly spraying another vessel containing 20 fruit flies with a solution of distilled water and adjuvant (5% Hasten™, v/v) resulted in a 0% Kill Ratio (that is, none killed) after 20 minutes.

### EXAMPLE 13

Two aerated transparent glass vessels containing 20 cockroaches each (American Cockroach, periplaneta americana), were sprayed separately with a 10:1 formulation as prepared in Example 9 and 5:1 formulation as prepared in Example 9. The containers were then placed in the sunlight (Cental Florida, Autumn). Within 4 hours all of the cockroaches were dead (100% Kill Ratio). As a control, untreated cockroaches remained alive.

### EXAMPLE 14

Four aerated transparent glass vessels containing 10 cockroaches each (American Cockroach, periplaneta americana), were treated separately as follows: Group 1 was sprayed with a 5:1 formulation as prepared in Example 9 then placed in the dark for 12 hours, followed by sunlight, resulting Kill Ratio=100% (all dead). Group 2 was not sprayed, placed in the dark for 12 hours, followed by sunlight, resulting Kill Ratio=0% (all alive). Group 3 was sprayed similarly to Group 1 but left in the darkness, resulting Kill Ratio=80%. Group 4 was not sprayed and was left in the darkness, resulting Kill Ratio=0%.

### EXAMPLE 15

A field area of approximately 91.5 cm×30.5 cm was plotted, staked and separated into a total of 6 sections, for control experiments and test sections. Plants in the plotted area included a wild mix of cyperus globulosus, brachiara plantaginea, lespedea striata and mimosa strigillosa. Test sections were sprayed with approximately 50 mL of a 5:1 formulation as prepared in Example 9. After 72 hours approximately 45% of the spray treated vegetation was destroyed. Control, untreated areas showed no effect.

### EXAMPLE 16

A field area was plotted and staked for control experiments and test sections. Plants in the plotted area included a wild mix of cyperus globulosus, brachiara plantaginea, lespedea striata and mimosa strigillosa. Test sections of 7.6 cm×183 cm were sprayed with approximately 300 mL of a 1:1:1 formulation (SJW extract concentrate:distilled water:adjuvant, v/v/v) as prepared in Example 10. After 72 hours significant vegetation was destroyed (>80%), and after approximately 10 days significant plant death was observed. Control, untreated areas showed no effect.

### EXAMPLE 17

Powdered sample from Example 2 and St. John's wort powder were preliminarily assessed for their insect and animal repellent properties as follows: A small line of extract powder was placed in the pathway of a small colony of ants. Ants preferably went around the powder line as opposed to crossing the line. Separately, animal food (dog food) treated with powder was not consumed by animals or pets. Untreated food was rapidly consumed.

What is claimed is:

1. A pesticide composition comprising extract selected from the group of plants consisting of Umbelliferae, Rutaceae, Leguminosae, Moraceae, Hypericaceae, Compositae, Berberidaceae, Rubiaceae, Simaroubaceae, Guttiferae, Polygonaceae, Asteraceae, Apiaceae, Araliaceae, Campanulaceae, and Solanaceae.

2. The composition of claim 1 wherein an effective concentration of the extract is 0.001% to 100% weight/weight.

3. The composition of claim 1 wherein the extract is applied in the form of a liquid, an emulsion, a powder, a fog, a spray, or an aerosol.

4. The composition of claim 1 further comprising adjuvant.

5. The composition of claim 1 further comprising additive.

6. The composition of claim 1 further comprising adjuvant and additive.

7. A method of preparing the composition of claim 1 in the absence of light.

8. A method for controlling pests comprising exposing said pests to an effective amount of the composition in claim 1.

9. The method of claim 8 which further comprises exposure to light.

10. The composition of claim 1 wherein said extract is derived from celery.

11. The composition of claim 1 wherein said extract is derived from St. John's wort.
